(19) United States
(12) Patent Application Publication
(10) Pub. No.: US 2026/0185172 A1
(43) Pub. Date: Jul. 2, 2026

(54) METHOD FOR MANUFACTURING DIRECT REDUCED IRON WITH A LOW CARBON CONTENT

(71) Applicants: ArcelorMittal, Luxembourg (LU); FORM ENERGY, INC., Somerville, MA (US)

(72) Inventors: Dmitri BOULANOV, Crown Point, IN (US); Mahdi FARAHANI, Munster, IN (US); Marcelo ANDRADE, East Chicago, IN (US)

(21) Appl. No.: 19/130,022

(22) PCT Filed: Dec. 15, 2023
(86) PCT No.: PCT/IB2023/062805

§ 371 Date: May 14, 2025

(30) Foreign Application Priority Data
Dec. 16, 2022 (WO) PCT/IB2022/062380

(51) Int. Cl. C21B 13/02; C21B 13/00

(52) U.S. Cl. CPC C21B 13/02; C21B 13/0073; C21B 2100/44; C21B 2100/66

(57) ABSTRACT

A direct reduction method to manufacture a direct reduced iron product 12 having a carbon content less than 1.8% by weight and a shaft furnace exit temperature lower than 65° C. A carbon-containing cooling gas 30 is introduced into the cooling zone 3 of the shaft furnace 1 with a flow rate higher than 800 Nm3/ton of Direct Reduced Iron produced.

This claims priority to International Patent Application PCT/IB2022/062380 filed on Dec. 16, 2022 which is hereby incorporated by reference herein.

The invention is related to a method for manufacturing direct reduced iron with a low carbon content.

### BACKGROUND

Direct reduced iron is produced from the direct reduction of iron ore (in the form of lumps, pellets, or fines) to iron by a reducing gas. Hematite and magnetite ores are examples of iron ores suitable for direct reduction. Reduced iron derives its name from the chemical change that iron ore undergoes when heated in a furnace at high temperatures in the presence of a reducing gas. Direct reduction refers to processes which reduce iron oxides to metallic iron at temperatures below the melting point of iron. The product of such solid-state processes is called direct reduced iron (DRI).

Among direct reduction methods are methods according to the brands MIDREX®, FINMET, ENERGIRON® (a HYL process), COREX®, FINEX®, etc., in which sponge iron is produced in the form of HDRI (hot direct reduced iron), CDRI (cold direct reduced iron), or HBI (hot briquetted iron) from the direct reduction of iron oxide carriers. Sponge iron in the form of HDRI, CDRI, and HBI usually undergoes further processing in electric arc furnaces.

### SUMMARY OF THE INVENTION

In many DRI processes, a reducing gas of CO and H2 is produced by either the continuous catalytic reforming of a hydrocarbon such as natural gas, petroleum distillates, methane, ethane, propane, butane, or other readily vaporizable hydrocarbon, or syngas from any source such as a coal gasifier. The reducing gas flows over the iron ore, reducing a substantial portion of the metal oxide, the gas remaining after the interaction with the iron ore being called a top gas, which typically exits at the top as the reducing gas typically flows upwardly.

The reduction process drives off the oxygen contained in various forms of iron ore (sized ore, concentrates, pellets, mill scale, furnace dust, etc.), in order to convert the ore to metallic iron, without melting it. The reduction process temperature typically may occur at 800 to 1100° C. During reduction, the iron oxide reacts with the reduction gas, for example according to the following reactions:

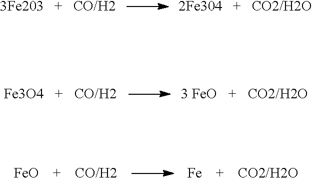

so that the ore is metallized.

After the reduction process, the metallized ore typically passes to a cooling section of the furnace where the metallized ore interacts with a cooling gas, usually natural gas (NG). NG is particularly efficient for cooling as thermal cracking of CH₄ is an endothermic reaction and CH₄ has a high heat capacity.

As the metallized ore is cooled or transitions into the cooling zone, the metallized ore typically undergoes carburization (i.e. the carbon content is increased) due to the NG or other cooling gases.

At the exit of the furnace the cooled DRI product may have a carbon content from 1.8 to 2.8% by weight, which is the required amount for subsequent steelmaking steps where this product will be used.

However, for some applications DRI with a lower carbon content, below 1.8% by weight, or more preferably below 1.5% or 1.2%, may be desired as carbon may be detrimental to the efficiency. One nonlimiting example may be for battery applications mentioned in patent application publication WO2022/103893, although other applications are possible. Methods for determining the carbon content by weight percentage can be those mentioned in WO2022/103893, though others known in the art may be used. WO2022/103893 is hereby incorporated by reference herein with the provision that for purposes of claim interpretation, language found in the incorporated by reference WO2022/103893 is subordinate to other language found in the present specification.

While one solution to obtain lower carbon DRI could be to suppress the cooling gas injection that causes carburization, this would result in a hot discharge of the product, which is typically reduced above 800° C. New equipment investment would be needed to handle such a hot product.

The present inventors thus have found a need for a method to produce a cold DRI (CDRI) product having a low carbon content.

The present invention solves this problem in one embodiment of the present invention by providing a method for manufacturing a direct reduced iron product in a shaft furnace having a reduction zone and a cooling zone, the method comprising:
injecting a reducing gas into the shaft furnace to reduce iron ore, a top gas exiting the shaft furnace, and
introducing a carbon-containing cooling gas into the cooling zone of the shaft furnace with a flow rate higher than 800 Nm3/ton of direct reduced iron produced, the direct reduced iron product having a carbon content less than 1.8% by weight and a temperature at an exit of the shaft furnace lower than 65° C.

The method of the embodiment of the present invention may also comprise the following optional characteristics considered separately or according to all possible technical combinations:
the direct reduced iron product has a carbon content less than 1.5% by weight, and more preferably less than 1.2% by weight;
wherein the carbon-containing cooling gas includes up to 20% in volume of CH₄;
the carbon-containing cooling gas includes the top gas, a reformed gas, the reducing gas, natural gas, or carbon dioxide;
the top gas is subjected to a water removal step before being used as cooling gas;
the top gas is subjected to a CO2 removal step before being used as cooling gas;
before injection into the shaft furnace, the cooling gas has a temperature from 40 to 80° C.;
a target of carbon content of the direct reduced iron product is defined, the gas composition to be provided in the cooling zone of the shaft furnace is determined, and the flow rate of the cooling gas is controlled so as to reach the defined target of carbon content in the direct reduced iron product, based on the determined composition of the gas;
varying a gas temperature at an outlet of the top gas scrubber in the range of 30-80° C.;
varying a CO2 amount present after the CO2 removal unit;
a minimum temperature in the reduction zone of the shaft furnace is defined, the temperature and the volume of gas in a transition zone of the shaft furnace between the reduction zone and the cooling zone is determined, and the temperature of the reducing gas before its injection into the shaft furnace is controlled, based on the determined temperature and volume of the gas in the transition zone so that the temperature in the reduction zone is above the defined minimum temperature;
after introduction in the cooling region of the shaft furnace the cooling gas upwardly flows through a part of the transition zone of the shaft furnace where the cooling gas is recovered and the recovered cooling gas is cooled, cleaned, and mixed with a make-up gas stream to form a new cooling gas to be injected in the cooling zone of the shaft furnace;
the make-up gas stream is chosen among the top gas, the reducing gas, a reformed gas, hydrogen, nitrogen, carbon dioxide, ammonia, or a combination of any of those gases; and/or
the make-up gas stream is added to the recovered cooling gas at a flow rate from 60 to 130 Nm3/ton of direct reduced iron produced.

In alternate embodiments, the present invention provides a method for manufacturing a direct reduced iron product in a shaft furnace having at least both of a reduction zone and a cooling zone, the method comprising: operating a shaft furnace to form the direct reduced iron product, the shaft furnace having a reduction zone and preferably having an operating temperature of at or above 800° C. while the shaft furnace is in operation; injecting a carbon-containing cooling gas at a cooling gas flow rate into a cooling zone of the shaft furnace in operation; and receiving the direct reduced iron product exiting from the cooling zone of the shaft furnace after injecting the cooling gas during operation of the shaft furnace, wherein the received direct reduced iron product has a carbon content below a predetermined level and a temperature below a predetermined temperature upon exiting from the cooling zone; the cooling gas flow rate being a flow rate selected such that greater than 800 Nm3/ton of DRI produced.

Other inventive embodiments may be disclosed herein in which carbon-containing cooling gas is provided at higher flow rates than normal, for example to increase existing flow rates in an existing DRI shaft furnace, with the aim of decreasing the normal carbon content of the DRI produced, for example to 1.8 percent by weight or less, while maintaining high metallization, for example to 90% or above, while still providing a cold DRI product, for example to a temperature at an exit of the shaft furnace lower than about 65° C. These higher flow rates of the carbon-containing cooling gas can include rates of greater than 800 Nm3/ton of DRI produced and can be in combination with any of the features described above alone or in combination.

The present invention also provides a method for manufacturing a direct reduced iron product in a shaft furnace having a reduction zone and a cooling zone, the method comprising:
injecting a reducing gas into the shaft furnace to reduce iron ore, a top gas exiting the shaft furnace to a top gas scrubber;
varying a gas temperature at an outlet of the top gas scrubber in the range of 30-80° C.;
introducing a carbon-containing cooling gas into the cooling zone of the shaft furnace, the direct reduced iron product having a carbon content less than 1.8% by weight, the carbon content being adjusted by the varying of the gas temperature.

The present invention also provides a method for manufacturing a direct reduced iron product in a shaft furnace having a reduction zone and a cooling zone, the method comprising:
injecting a reducing gas into the shaft furnace to reduce iron ore, a top gas exiting the shaft furnace to a CO2 removal unit;
varying a CO2 amount present after the CO2 removal unit;
introducing a carbon-containing cooling gas into the cooling zone of the shaft furnace, the direct reduced iron product having a carbon content less than 1.8% by weight, the carbon content being adjusted by the varying of the CO2 amount.

The present invention also provides a cold DRI product produced according to the methods of the present invention.

### BRIEF DESCRIPTION OF THE DRAWINGS

Other characteristics and advantages of the invention will emerge clearly from the description of it that is given below by way of an indication and which is in no way restrictive, with reference to the appended figures in which:

FIG. 1 illustrates the layout of a direct reduction plant allowing to perform a method according to an embodiment of the present invention; and

FIG. 2 illustrates the layout of a direct reduction plant allowing to perform a method according to another embodiment of the present invention.

Elements in the figures are illustration and may not have been drawn to scale.

### DETAILED DESCRIPTION OF PREFERRED EMBODIMENTS

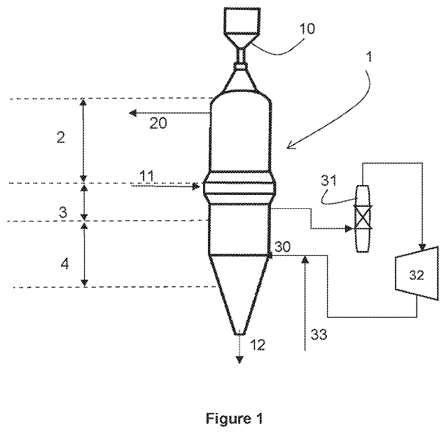

FIG. 1 illustrates a layout of a direct reduction plant allowing performance of one embodiment of the method according to the present invention.

Exemplary DRI manufacturing equipment includes a DRI furnace 1 comprising from top to bottom a charging device 10 for iron ore, the iron ore travelling through the furnace 1 by gravity. The furnace has a reduction section 2 located in the upper part of the furnace 1, a transition section 3 located in the midpart of the shaft, and a cooling section 4 located at the bottom and an outlet or exit from which the direct reduced iron 12 is finally extracted. The transition section 3 in the exemplary embodiment typically has a length to separate the reduction section from the cooling section, the length allowing for an independent control of the reducing and cooling sections, and where the cooling gas can be extracted.

The direct reduction furnace 1 is charged at its top with oxidized iron ore. This oxidized iron is reduced into the furnace 1 by a reducing gas 11 injected into the furnace and flowing counter-current from the oxidized iron. Reduced iron 12 exits the cooling section 4 at bottom opening or exit of the furnace 1 at a temperature below 65° C., preferably from 50° C. to 65° C., for further processing, such as briquetting, before being used in subsequent steelmaking steps. Reducing gas, after having reduced iron, exits at the top of the furnace as a top reduction gas 20 (TRG).

In one embodiment of the method according to the present invention a carbon-containing cooling gas 30 is injected into the cooling zone of the shaft furnace at a flow rate superior to 800 Nm3/ton of produced DRI. By introducing gas in such a quantity, the inventors have discovered that it allows to have a steeper temperature gradient in the cooling/transition zones allowing a lower carburization of the product while avoiding its reoxidation. This thus allows for cooling the DRI to the required temperature while limiting the carburization and keeping a high degree of metallization, preferably above 90%.

The degree of reduction of DRI is normally expressed as the percent metallization of the product. It is the ratio of the metallic iron present in DRI divided by the total iron present in DRI. The degree of metallization depends largely on the type of reduction process being used. Low degree of metallization leads to economic disruption such as higher energy consumption, higher slag volume, more heat time, and lower yield during steelmaking.

Nm3 is a unit of measurement of the quantity of gas which corresponds to the content of a volume of one cubic meter, for a gas under normal conditions of temperature and pressure (0° C. and 1 atm).

The carbon-containing cooling gas 30 is preferably chosen so as to have a high heat capacity to remove heat from the solid while limiting needed gas volume and have an endothermic reaction with the DRI product. The carbon-containing cooling gas 30 preferably comprises methane CH₄, and most preferably up to 20% in volume of CH₄.

In a preferred embodiment as illustrated in FIG. 1, the cooling gas upwardly flowing through the cooling zone and the transition zone is captured in the transition zone. This extracted cooling gas usually has a temperature around 300-400° C. In a preferred embodiment it is subjected to a cooling and dewatering step in a cooling equipment 31, preferably a scrubber, and to a cleaning step in a cleaning equipment 32. Optionally cleaned and dewatered gas is then mixed with a make-up gas stream 33 before being re-injected into the cooling zone of the furnace.

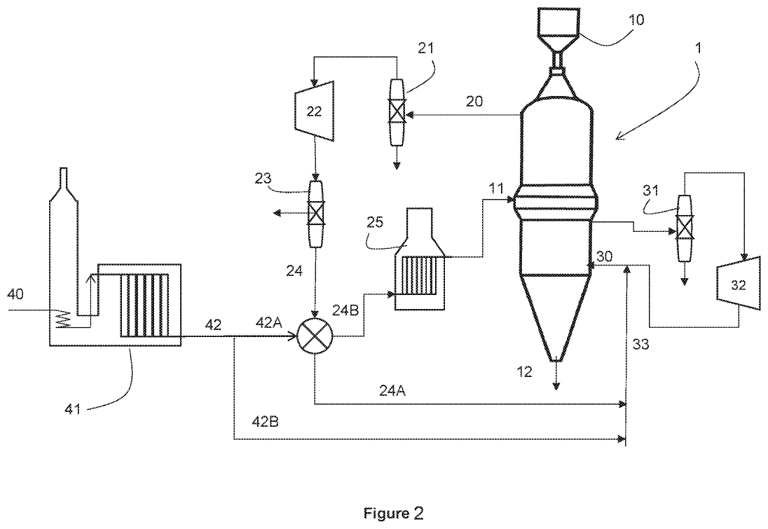

In another embodiment as illustrated in FIG. 2, the reduction top gas 20 exiting the DRI shaft 1 is collected in a pipe and cooled to 30 to 80° C. The top gas 20 then can optionally be connected to a scrubber 21 to remove water and, also optionally, to a CO2 removal equipment 23. A compression step in a compressor 22 may be performed between both or after the CO2 removal equipment 23. The top gas exiting from the DRI shaft usually comprises H2, CO, CH₄, H2O, CO2 and N2 in various proportions. The top gas scrubbing operation allows removing water vapor from the rest of the stream to improve its reduction potential.

The top gas after scrubber 21 usually comprises, in volume, from 43 to 57% of H2, from 13 to 28% of CO, from 12 to 18% of CO2, from 2 to 12% of CH4, from 1 to 4% of H2O and from 0-3% of N2. If subjected to a partial CO2 removal step in the CO2 removal equipment 23 it usually comprises from 50 to 69% of H2, from 15 to 20% of CO, from 2 to 13% of CO2, from 9 to 14% of CH4, from 1 to 4% of H2O and from 0-3% of N2.

Once the top gas 24 exits the scrubber 21 or the CO2 removal equipment 23, it can optionally be compressed and used as cooling gas 30 and/or make-up gas stream 33. It could also be split into two or more streams, one stream 24A being used as cooling gas 30 and/or make-up gas stream 33 and the other stream 24B used as part of the reducing gas 11. When use as a make-up gas stream it can be mixed with the reducing gas 11, natural gas, hydrogen, nitrogen, carbon dioxide, ammonia, or a combination of any of those gases. The make-up gas stream is added to the recovered cooling gas at a flow rate from 60 to 80 Nm3/ton of DRI produced.

In another embodiment as also illustrated in FIG. 2, the top gas 24 may also be mixed with a reformed gas 42 exiting from a reformer 41. In a reformer a fuel 40, usually Natural gas, is turned into a reformed gas 42A, 42B mainly composed of CO, H2, CO2 and a non-reformed part of CH4. Typical composition of a reformed gas is, percentages being expresses in volume, from 54 to 75% of H2, from 14 to 35% of CO; from 2 to 7% of CO2; up to 5% of CH4, up to 6% of H2O and up to 3% of N2.

This reformed gas 42A is mainly used to produce the reducing gas 11, after having optionally being subjected to a heating step in a heater 25, either alone or in a combination with the recycled top gas 24B. But the reformed gas 42B can also be used as cooling gas 30 and/or make-up gas stream 33.

In a preferred embodiment, the flow rate of the cooling gas 30 and, thus optionally, the flow rate of make-up gas stream 33 is controlled according to a defined target of carbon to be reached in the DRI product 12 and of a determination of the gas composition in the cooling zone of the shaft furnace. This determination may be done by measurement or thermodynamic modelling.

As a matter of example if the carbon content of the DRI product must be lowered to reach the target, a non-carbon containing gas such as hydrogen or nitrogen may be added as make-up gas stream and its flow rate increased. On the contrary if the carbon content needs to be increased, while remaining lower than 1.8% in weight, it is possible to reduce the flow rate of make-up gas stream and/or adding reformed gas or natural gas as the make-up gas stream.

The carbon content of the DRI product also can be adjusted by varying the gas temperature at the outlet of top gas scrubber 21 in the range of 30-80° C. that changes water vapor content of reducing gas 11. The lower limit is a function of the available cooling water temperature while upper limit is conditioned by the requirement to maintain the reducing gas quality. The exact upper limit value depends on the content of CO2 in recycled reducing gas.

The CO2 content in the recycled reducing gas can also be changed to adjust carbon content of product DRI. This CO2 content change can be done by varying the rate of recycling reducing gas bypassing CO2 removal unit 23. The lower limit of CO2 content depends on the capability of CO2 removal unit (if all gas passes through the removal unit) and typically can be as low as ˜2% while the upper limit must be low enough to maintain the reducing gas quality. Typically, CO2 content in the recycled gas after the scrubber should be below ˜18%.

In another embodiment a minimum temperature in the reduction zone of the shaft furnace is defined and the temperature and the volume of gas in the transition zone of the shaft furnace is determined so that the temperature of the reducing gas 11 before its injection into the shaft furnace is controlled to have a temperature in the reduction zone above the defined minimum temperature. This process ensures the reduction of iron despite the injection of large volumes of cooling gas.

Features of the embodiments previously described are compatible with one another. The carbon-containing cooling gas 30 may be chosen among the top reduction gas 24, the reformed gas 42B, the reducing gas 11, natural gas, carbon dioxide, or a combination of any of those gases. It is preferentially introduced into the furnace at a temperature from 40° C. to 80° C. The make-up gas stream 33 may be chosen among the reduction top gas 24, the reformed gas 42B, the reducing gas, hydrogen, nitrogen, carbon dioxide, ammonia, or a combination of any of those gases. The make-up gas stream is added to the recovered cooling gas at a flow rate from 60 to 80 Nm3/ton of DRI produced.

In all embodiments the cooling gas 30 and/or the make-up gas stream 33 are chosen among the different gases described or a mixture of them according to the plant configuration and environment. When, for example, hydrogen is available in great quantity hydrogen will be preferentially used as make-up gas stream. If, in another case, top gas recovery is already performed and thus required equipment are already available, top gas may then be preferably used.

### Non-Limiting Example

A trial was performed in an HYL reduction plant comprising a reformer as illustrated in FIG. 2 with a production rate of 47 T/h of DRI. The plant was initially operating with recycling of the cooling gas and injection of NG as the make-up gas stream. In the trial, NG was gradually replaced by an increased flow rate of reformed gas. The reformed gas had the following composition: 72.6% v of H2, 15.1% v of CO, 7.2% v of CO2, 3.8% v of CH4 0.4% v of N2 and 1% v of H2O. This transitional phase was performed until a steady state was reached allowing to perform one embodiment of the method according to the present invention. The flow rate of the cooling gas introduced into the furnace was of 833 Nm3/ton of DRI produced, this flow rate including a make-up gas stream made of 39.6 Nm3 of Natural Gas per ton of DRI produced, mixed with 83.3 Nm3 of reformed gas per ton of DRI produced. With those conditions it was possible to obtain a DRI product with a metallization of 93% and a carbon content of 0.6% in weight.

1-15. (canceled)

16: A method for manufacturing a direct reduced iron product in a shaft furnace having a reduction zone and a cooling zone, the method comprising:
injecting a reducing gas into the shaft furnace to reduce iron ore, a top gas exiting the shaft furnace, and
introducing a carbon-containing cooling gas into the cooling zone of the shaft furnace with a flow rate higher than 800 Nm3/ton of direct reduced iron produced, the direct reduced iron product having a carbon content less than 1.8% by weight and a temperature at an exit of the shaft furnace lower than 65° C.

17: The method according to claim 16 wherein the direct reduced iron product has a carbon content below 1.5% in weight

18: The method according to claim 16 wherein the direct reduced iron product has a carbon content below 1.2% in weight.

19: The method according to claim 16 wherein the carbon-containing cooling gas includes up to 20% in volume of CH₄.

20: The method according to claim 16 wherein the carbon-containing cooling gas includes the top gas, a reformed gas, the reducing gas, natural gas, or carbon dioxide.

21: The method according to claim 20 wherein the top gas is subjected to a water removal step before being used as cooling gas.

22: The method according to claim 20 wherein the top gas is subjected to a CO₂ removal step before being used as cooling gas.

23: The method according to claim 16 wherein, before injection into the shaft furnace, the cooling gas has a temperature from 40 to 80° C.

24: The method according to claim 16 wherein:
a. a target of carbon content of the direct reduced iron product is defined,
b. the gas composition to be provided in the cooling zone of the shaft furnace is determined,
c. the flow rate of the cooling gas is controlled so as to reach the defined target of carbon content in the direct reduced iron product, based on the determined composition of the gas.

25: The method according to claim 16 further comprising:
defining a minimum temperature in the reduction zone of the shaft furnace,
determining the temperature and the volume of gas in a transition zone of the shaft furnace between the reduction zone and the cooling zone,
controlling the temperature of the reducing gas before its injection into the shaft furnace, based on the determined temperature and volume of the gas in the transition zone so that the temperature in the reduction zone is above the defined minimum temperature.

26: The method according to claim 16 wherein after introduction in the cooling region of the shaft furnace the cooling gas upwardly flows through a part of the transition zone of the shaft furnace where the cooling gas is recovered and the recovered cooling gas is cooled, cleaned, and mixed with a make-up gas stream to form a new cooling gas to be injected in the cooling zone of the shaft furnace.

27: The method according to claim 26 wherein the make-up gas stream is chosen among the top gas, the reducing gas, a reformed gas, hydrogen, nitrogen, carbon dioxide, ammonia, or a combination of any of those gases.

28: The method according to claim 26 wherein the make-up gas stream is added to the recovered cooling gas at a flow rate from 60 to 130 Nm3/ton of direct reduced iron produced.

29: The method according to claim 16 further comprising varying a gas temperature at an outlet of the top gas scrubber in the range of 30-80° C.

30: The method according to claim 16 further comprising varying a CO2 amount present after the CO2 removal unit.
